(19) United States
(12) Patent Application Publication
(10) Pub. No.: US 2017/0242225 A1
(43) Pub. Date: Aug. 24, 2017

(54) THIN OPTICAL SYSTEM AND CAMERA

(71) Applicant: Orlo James Fiske, Santa Barbara, CA (US)

(72) Inventor: Orlo James Fiske, Santa Barbara, CA (US)

(21) Appl. No.: 15/591,534

(22) Filed: May 10, 2017

Related U.S. Application Data
(63) Continuation of application No. PCT/US15/61285, filed on Nov. 18, 2015.
(60) Provisional application No. 62/081,909, filed on Nov. 19, 2014.

(51) Int. Cl. G02B 13/00; G02B 26/10; G02B 26/08; G02B 7/02; G02B 7/182

(52) U.S. Cl. CPC G02B 13/0055; G02B 7/021; G02B 7/1821; G02B 26/085; G02B 26/105

(57) ABSTRACT

A camera module (170) includes a miniature scanning mirror (120), lens elements (163a to 163d) corresponding to thin lateral lens slices, and a short, wide imaging sensor (165). As the scanning mirror (120) pivots to scan a scene, the imaging sensor (165) captures successive image segments. Multiple image segments are stitched together by software running on a digital processor to provide a complete image. The assembly of lens elements (163a to 163d) may include moveable elements to allow variable focus, variable magnification and image stabilization, and may utilize refraction, reflection, diffraction and/or planar optical elements. The camera module (170) may be less than 5 millimeters thick while allowing long focal length lenses and increased light collecting area. Other embodiments include a switchable scan mirror with two apertures and a dual-camera system that provides binocular images and video.

### CROSS REFERENCE TO RELATED APPLICATIONS

The present application is a continuation application of PCT Application Serial No. PCT/US2015/61285, filed 18 Nov. 2015, which claims priority from U.S. Provisional Application No. 62/081,909 filed on 19 Nov. 2014, the contents of which are herein incorporated by reference in its entirety.

### FIELD OF THE INVENTION

This invention relates generally to optics and camera modules, and more particularly to thin, lightweight optics and camera modules for portable devices such as cameras, cellular telephones and the like.

### BACKGROUND OF THE INVENTION

Pocket cameras have become ubiquitous, particularly in the form of cell phone cameras. FIG. 1 shows a cutaway view of a typical configuration of a cell phone 10. A miniature camera module 12, including a complete optical system, typically fits in a tiny package installed inside the cell phone case, as shown. Camera modules of this type are typically on the order of 8 millimeters wide, 8 millimeters long, and 6 millimeters thick. FIG. 2 shows a section view of an optical system 20 for a cell phone camera module. Lens elements 22a, 22b, 22c and 22d focus an image on image sensor 28, which captures the image for transfer to a microprocessor and storage. As depicted, one or more of the lens elements may be moved along the optical path to vary the focus. Several billion camera modules of this type are now produced annually worldwide for use in cell phones and other compact electronic devices.

As cell phone technology has matured cell phones have grown progressively thinner, with most popular models now between 6 and 10 millimeters thick. This places extreme limitations on the capabilities of the camera modules used, since the short optical path from the front of the lens to the image sensor severely restricts the practical diameter and focal length of the lens. The entrance pupil of the lens may be less than 2 millimeters, providing just 3 square millimeters of light collecting area or less, and insufficient room is available to allow variable magnification (zoom).

Some cell phone manufacturers have elected to allow the camera module lens to protrude from the cell phone case, or even include a section of increased thickness in the case, in order to ease the constraints on camera module design and provide improved capabilities. These options result in more bulk and clearly undesirable aesthetics. A different method sometimes used to improve cell phone camera capability, as illustrated in FIG. 3, is to add an external lens 30. This approach adds cost and complexity, and is far less convenient than an integral lens.

Another method used to improve camera module performance employs a path-folding optical design such as the one depicted in FIG. 4. Light rays from a scene of interest enter the camera module through aperture 41, reflect from angled mirror 42, pass through lens 43, reflect from angled mirror 44, and focus on image sensor 46. This design allows a longer optical path than the design of FIG. 2, but with the unfortunate result that either the camera module must be thick enough to fit a lens of large enough diameter to provide good optical performance or the lens diameter must remain small, providing little performance improvement.

FIG. 5 shows a perspective view of the optical path of a conventional lens system and camera 50 comprising four lens elements and an image sensor 54, which illustrates why it is so difficult to fit such a system in a very thin package. In operation, light rays 51 are focused by lens elements 52a, 52b, 52c and 52d onto pixel array 56 of image sensor 54. The pixel values are read out by electronic components on image sensor 54 and transferred to an external microprocessor for further processing, storage, and display. Some or all of the lens elements in lens system 50 may be moveable along the optical axis, varying their distance from the image plane to allow variable focus and/or variable magnification, i.e. zoom. High performance lens systems may have more than four lens elements. Particularly in the case of telephoto or zoom lenses, substantial separation is required between some elements of the optical path to allow sufficient space for light convergence and/or divergence. This typically results in a total telephoto or zoom lens length that is several times longer than the lens diameter.

FIG. 6 depicts the pixel array of an image sensor used in many cell phones, in this case a 1/3.2″ image sensor chip with 2448 by 3264 pixels, for a total of 8 megapixels (7,990,272 pixels, to be precise). Circular lens elements like those of FIG. 5 focus a circular image onto the image plane, and in order to provide complete coverage of the pixel array that image must be larger than the array.

While cell phones have grown thinner, they are relatively spacious in terms of width and height. In fact, over time they have tended to grow wider and taller, with some now approaching 80 mm wide and 160 mm tall. Some camera module developers have taken advantage of this area by providing multiple tiny cameras viewing different parts of the same scene in parallel. They then electronically combine some or all of the images captured by these cameras. This may increase the final image resolution and in some cases provide magnification of up to perhaps four or five times, at the cost of more complex and expensive hardware, the need to develop highly sophisticated image processing algorithms and demanding computational requirements in the mobile device.

In comparison, some commonly available cameras include an integral zoom lens capable of optically magnifying an image by a factor of 40 to 60 times. Similar capability would be highly advantageous if it could be included in a low-cost camera module suitable for use in cell phones and other mobile devices, but none of the usual methods used to improve camera module capability are likely to ever come close to achieving this.

FIG. 7 shows a perspective view of a conventional MEMS (Microelectromechanical Systems) scanning mirror 70. Pivoting mirror 74 is created typically using known photolithography methods to etch slots 72a and 72b in silicon chip 71, leaving torsion springs 73a and 73b connecting mirror 74 to the surrounding frame of chip 71. A reflective surface is deposited on mirror 74, and conductive loop 75 is formed, again using lithographic means, on the top surface of chip 71. The ends of conductive loop 75 form bonding pads 76a and 76b. Bonding wires (not shown) connect bonding pads 76a and 76b to the package (not shown) in which scanning mirror 70 is mounted. This package is typically designed to be soldered onto a circuit board, which provides an external source of electric current for conductive loop 75. Magnets are mounted inside the chip package to create magnetic field 77.

FIG. 8 is a section view of mirror 74 and magnets 82a, 82b and 82c that illustrates the operation of MEMS mirror 70 of FIG. 7. Magnets 82a, 82b and 82c create magnetic field 77, which interacts with an electric current passing through conductive loop 75 according to Fleming's left-hand rule for motors. This creates an upward force on one side of mirror 74 where the current in loop 75 flows in one direction, and a downward force on the opposite side of mirror 74 where the current in loop 75 flows in the opposite direction, causing mirror 74 to rotate along a limited angle around axis 78. If the direction of the electric current through conductive loop 75 is reversed the upward and downward forces are also reversed, causing mirror 74 to rotate in the opposite direction around axis 78. By controlling the current through conductive loop 75 the speed of rotation and the final angle of mirror 74 may be rapidly and precisely varied, subject to the counterforce and material limitations of torsion springs 73a and 73b. MEMS scanning mirrors of this type may be as small as a few millimeters long or even less, may provide rotation angles on the order of 20-30 degrees in both directions, and may achieve scanning speeds of several hundred hertz or more. However, the placement of conductive loop 75 on top of mirror 74 adds fabrication steps and decreases the reflective area of the mirror, both of which increase the cost of a mirror of a specific size. The need to constrain the width of the conductor used to form loop 75, and thereby minimize loss of mirror area, also creates relatively high current resistance through the loop, decreasing performance and making the scanning mirror less power efficient than is desirable.

Given these factors, there is a clear need for a low cost optical system and camera module design that exploits the width and height of cell phones and other portable electronic devices to achieve improved camera performance, while reducing thickness to allow these devices to remain thin and light.

### SUMMARY OF THE INVENTION

A camera module includes a miniature scanning mirror and lens assembly disposed along the optical path of the system. The scan mirror design provides tiny package dimensions, high scan rates, low power requirements and low cost. The lens elements correspond to thin lateral slices taken from the center of circular lenses, and focus an image segment onto an imaging sensor. The term scan mirror, mirror segment, and scan mirror segment are used interchangeably herein and refer to the mirror structure of the present invention. The imaging sensor corresponds to a thin slice taken from a rectangular image sensor. As the scanning mirror pivots on one axis to scan the scene of interest, the imaging sensor captures successive image segments. Multiple image segments are stitched together by software running on a digital processor to provide a complete image. The lens assembly may include moveable elements to allow variable focus and variable magnification, and may utilize refraction, reflection, diffraction and/or planar optical elements. The camera module may be less than 5 millimeters thick while allowing long focal length lenses and far more light collecting area than previously possible in a camera of this thickness. Other embodiments include a switchable scan mirror with two apertures and a dual-camera system that provides binocular images and video.

In accordance with a first aspect, the present invention provides a camera module including: a first entrance pupil for transmission of light from a photographic subject; a mirror segment having a longitudinal axis of rotation, the mirror segment being movable about the longitudinal axis thereby reflecting the light; a plurality of truncated lenses aligned to transmit and focus the light reflected from the mirror segment; and an image sensor aligned to receive the light transmitted and focused by the plurality of truncated lenses for subsequent digital manipulation thereof.

In accordance with another aspect, the present invention provides a microelectromechanical device including: a mirror segment being movable via torsion springs located at opposite ends thereof, the torsion springs being located between the mirror segment and contact pads, the contact pads being mounted to a trapezoidal wedge-shaped base at raised mounting pads located at each end of the trapezoidal wedge-shaped base, the trapezoidal wedge-shaped base being lower than the raised mounting pads in an area beneath the mirror segment so as to enable rotation of the mirror segment, the mirror segment being formed from a conductive material which magnetically interacts with magnets embedded in the trapezoidal wedge-shaped base so as to move the mirror segment between each the orientation upon passing an electric current through the mirror segment.

In accordance with still another aspect, the present invention provides a bidirectional camera module including: a first entrance pupil for transmission of light from a photographic subject; a second entrance pupil for transmission of light from another photographic subject, the second entrance pupil located opposite the first entrance pupil; a mirror segment having a longitudinal axis of rotation, the mirror segment being movable about the longitudinal axis thereby reflecting the light; a curved stationary base within which the mirror segment is selectively rotated between a first position facing the first entrance pupil and a second position facing the second entrance pupil; a plurality of truncated lenses aligned to transmit and focus the light reflected from the mirror segment while the mirror segment is oriented in either the first position or the second position; and an image sensor aligned to receive the light transmitted and focused by the plurality of truncated lenses for subsequent digital manipulation thereof; wherein selective rotation of the mirror is provided by a shape memory alloy wire electrically and mechanically connected to the curved stationary base.

In accordance with yet another aspect, the present invention provides a method of digitally stitching image segments to form a single image, the method including: capturing consecutive image segments obtained from an entrance pupil configured for transmission of light from a photographic subject; transmitting each of the consecutive image segments via a mirror segment having a longitudinal axis of rotation, the mirror segment being movable about the longitudinal axis thereby reflecting the light through a plurality of truncated lenses aligned to transmit and focus the light reflected from the mirror segment during consecutive discrete orientations of the mirror segment; receiving the light transmitted and focused by the plurality of truncated lenses at an image sensor; and assembling each of the consecutive image segments corresponding to each of the consecutive discrete orientations of the mirror segment into a single image representative of the photographic subject.

In accordance with still another aspect, the present invention provides a method of digitally gathering image scene pixels to form a single image, the method including: capturing a plurality of sequential image scene pixels obtained from an entrance pupil configured for transmission of light from a photographic subject; transmitting each of the sequential image scene pixels via a mirror segment having a longitudinal axis of rotation, the mirror segment being continuously movable about the longitudinal axis at a constant angular velocity and reflecting the light including each of the sequential image scene pixels through a plurality of truncated lenses aligned to transmit and focus the light reflected from the mirror segment during continuous movement of the mirror segment; receiving the light including each of the sequential image scene pixels transmitted and focused by the plurality of truncated lenses at an image sensor; and assembling each of the sequential image scene pixels via time delay and integration into a single image representative of the photographic subject.

These and other aspects will become apparent from the following drawings and detailed descriptions of exemplary embodiments.

### BRIEF DESCRIPTION OF THE DRAWINGS

FIG. 1 is a cutaway view of a prior art cell phone showing the placement and relative size of the camera module.

FIG. 2 is a section view of a prior art optical system for a miniature camera.

FIG. 3 shows a prior art detachable telephoto lens mounted on a cell phone.

FIG. 4 depicts a prior art optical path-bending camera system.

FIG. 5 shows a perspective view of prior art imaging elements of a camera system.

FIG. 6 depicts a 1/3.2″, 8 megapixel image sensor chip of the prior art.

FIG. 7 shows a perspective view of a prior art MEMS scanning mirror.

FIG. 8 is a section diagram of the prior art actuation mechanism of the MEMS scanning mirror of prior art FIG. 9.

FIG. 9A shows a perspective view of imaging elements according to the present invention.

FIG. 9B shows a perspective view of a second embodiment of imaging elements according to the present invention.

FIG. 10 depicts the pixel array of an image sensor chip according to the present invention.

FIG. 11 is a perspective view of a MEMS scanning mirror according to the present invention.

FIG. 12 is a plan view of the mirror element of the scanning mirror of FIG. 11.

FIG. 13 is a section view of the scanning mirror of FIG. 11.

FIG. 14 is a section diagram of the actuation mechanism the scanning mirror of FIG. 11.

FIG. 15 is a section diagram of a second embodiment of the actuation mechanism of FIG. 14.

FIG. 16 is a section view of an optical path according to the present invention.

FIG. 17 shows a section view of a camera module according to the present invention.

FIG. 18 shows a perspective view of the camera module of FIG. 17.

FIG. 19 shows a partial cutaway perspective view of a thin compact device, such as a cell phone, employing the camera module of FIG. 18.

FIG. 20 is a diagram of the active components of a camera module according to the present invention.

FIG. 21 depicts an image scanning procedure used by a camera module according to the present invention.

FIG. 22 is a diagram illustrating a second scanning procedure that may be used by camera modules according to the present invention.

FIG. 23A shows a section view of a zoom telephoto camera module according to the present invention.

FIG. 23B shows a plan view of the zoom telephoto camera module of FIG. 23A.

FIG. 24A shows a section view of a thin camera module employing reflective optics according to the present invention.

FIG. 24B shows a plan view of the thin camera module of FIG. 24A.

FIG. 25A shows a partial section view of a two-aperture camera system with a reversible scan mirror.

FIG. 25B shows a second partial section view of the two-aperture camera system of FIG. 25A.

FIG. 26A shows a section view of the reversible scan mirror actuation mechanism of the camera system of FIG. 25A.

FIG. 26B shows a second section view of the reversible scan mirror actuation mechanism of the camera system of FIG. 25A.

FIG. 26C shows a plan view of the reversible scan mirror actuation mechanism of FIG. 26A.

FIG. 27 is a section view of another embodiment of a thin camera system.

FIG. 28 shows a perspective view of an electronic binocular system according to the present invention.

FIG. 29 shows a section view of the thin electronic binocular system of FIG. 28.

FIG. 30 shows a section view of another embodiment of the thin electronic binocular system of FIG. 28.

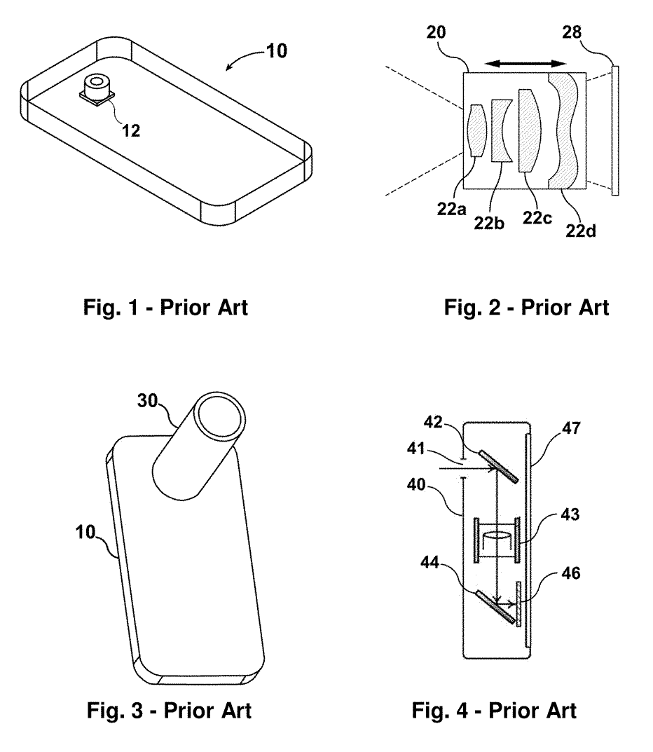

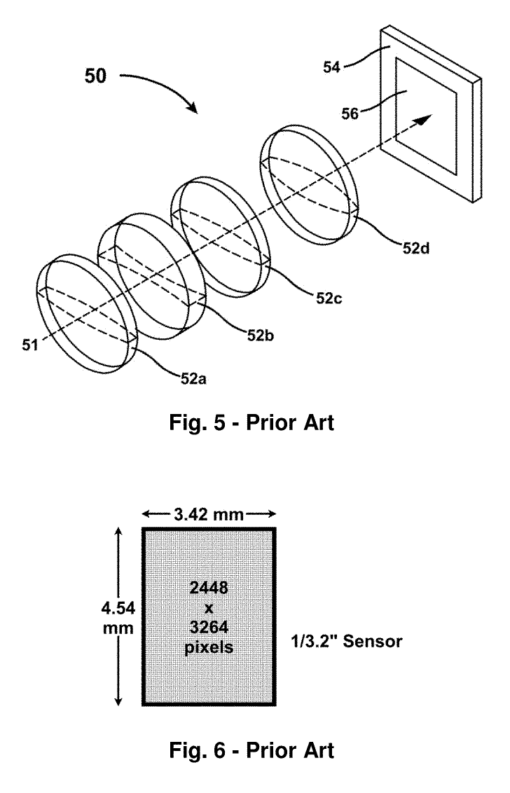

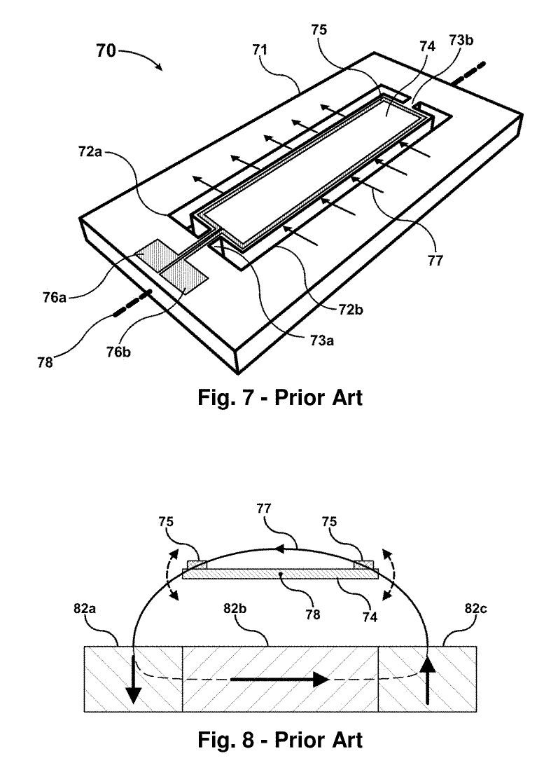

### DETAILED DESCRIPTION

The following detailed description provides examples of presently contemplated modes of implementing embodiments of the invention. This description is not to be taken in a limiting sense, but is made merely for the purpose of illustrating general principles of embodiments of the invention. The scope of the invention will be best defined by the claims.

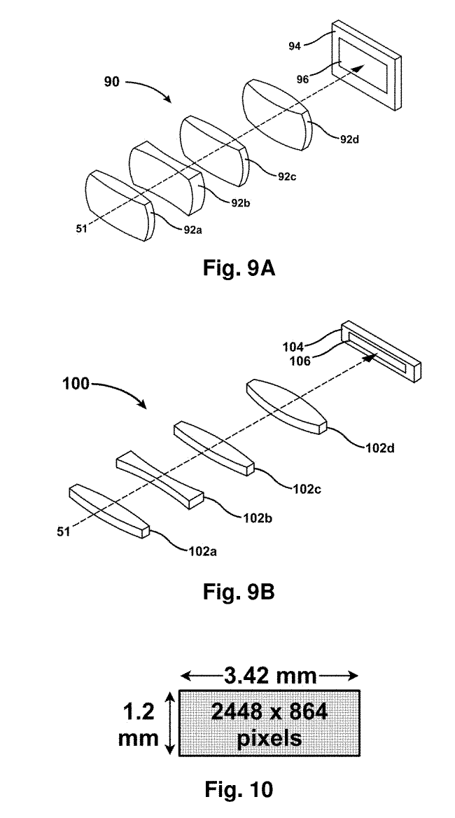

FIG. 9A shows a perspective view of example optical path 90 according to the present invention. Imaging elements are shown in the form of lenses 92a, 92b, 92c and 92d which are each a truncated lens. Truncated lenses for purposes of the present invention are those thin lateral slices taken from the center of a circular lens of a conventional optical path. Accordingly, the terms lens in the context of the present invention shall be construed to be a truncated lens. Such truncated lenses are reduced to one-half as tall as they are wide in order to decrease the vertical space required for the lens. Instead of a circular image, a truncated lens in accordance with the present invention will focus light rays 51 into a roughly rectangular image, wider than tall, that falls on pixel array 96 of image sensor 94.

FIG. 9B shows a perspective view of second example optical path 100 according to the present invention. Lens elements 102a, 102b, 102c and 102d again correspond to circular lens elements of a conventional optical path and are also the shape of slices taken out of the center of circular lens elements so as to each be a truncated lens, but in this example such lenses are one-tenth as tall as they are wide, which reduces the vertical space required even further. In other embodiments larger or smaller ratios may be used to create the appropriate aspect ratio for the selected image sensor, as described below. Instead of a circular image, such lenses focus light rays 51 into a wide, short rectangular image that falls on pixel array 106 of image sensor 104. Lens elements as shown in FIG. 9A and FIG. 9B may be glass or plastic lenses fabricated using conventional precision molding techniques.

FIG. 10 depicts a pixel array of an image sensor according to the present invention. In this example the pixel array has the same width and the same number of horizontal pixels as a conventional 1/3.2″ image sensor, but the pixel array is reduced to 1.2 mm and only 864 pixels tall (one-fourth of 3264 plus margin), thus reducing the size and cost of the image sensor. The size reduction along one dimension of the pixel array corresponds to the size reduction of the particular lens elements selected for any specific camera module design. In this case, lens elements would be selected to provide an image that covers a rectangle 864 pixels tall and 2448 pixels wide. As described below, four image segments with these dimensions will be combined to provide a final image 3264 pixels tall and 2448 pixels wide, i.e. the same size image as produced by a conventional 1/3.2″ image sensor. In other embodiments the pixel array may have larger or smaller dimensions and a larger or smaller number of horizontal or vertical pixels. In the most extreme embodiment the pixel array could have a single row of pixels.

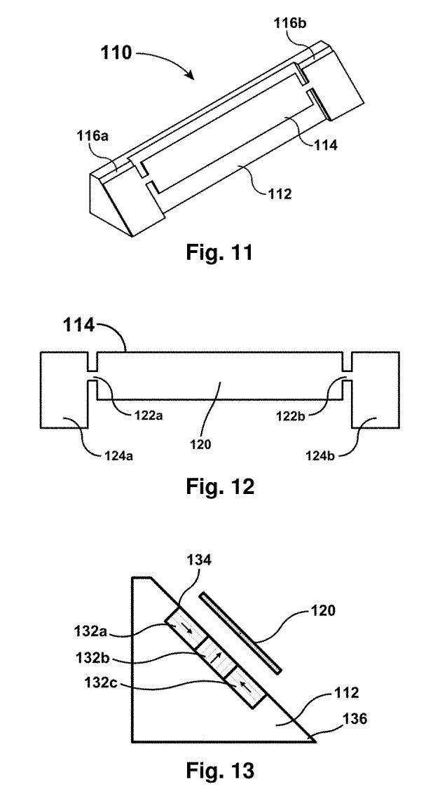

FIG. 11 is a perspective view of MEMS scanning mirror 110 according to the present invention. Mirror element 114 is bonded, soldered or otherwise attached to mounting pads 116a and 116b of mirror base 112. The mirror base 112 is itself formed in a generally trapezoidal wedge-shape. T

FIG. 12 is a plan view of mirror element 114 of MEMS scanning mirror 110. Mirror element 114 is fabricated by cutting or by photolithography applied to a single piece of material such as a wafer or thin plate. The material may be silicon, a metal such as aluminum, a composite incorporating fibers such as carbon fiber with, for example, a spin-coated resin to bond the fibers together and provide a smooth surface, or any other appropriate material. Mirror segment 120 provides the mirror surface, narrow connections 122a and 122b form torsion springs, and end areas 124a and 124b provide contact pads. As described below, the design of other components of MEMS scanning mirror 110 eliminates the need for the conductive loop that has been deposited on top of prior art MEMS scanning mirrors and which increased the required size of the scanning element while reducing performance.

FIG. 13 is a transverse section view of MEMS scanning mirror 110, taken anywhere along mirror segment 120. Groove 134 is formed in mirror base 112 by removing material or otherwise fabricating mirror base 112 with the required shape, such as by molding. Magnets 132a, 132b and 132c are bonded into groove 134 with the polarities shown. Groove 134 and magnets 132a, 132b and 132c typically extend from connection 122a to connection 122b making them about the same length as mirror segment 120. By making mounting pads 116a and 116b of mirror base 112 higher than (i.e., raised relative to) the area under mirror segment 120, sufficient space is left between mirror segment 120 and magnets 132a, 132b and 132c to allow mirror segment 120 to rotate the desired angle without contacting the magnets. Although the embodiment of MEMS scanning mirror 110 shown in FIG. 13 reflects light through a 90 degree angle when centered, other embodiments may provide a larger or smaller angle by changing corner angle 136 of mirror base 112 and the resulting angle of mirror segment 120.

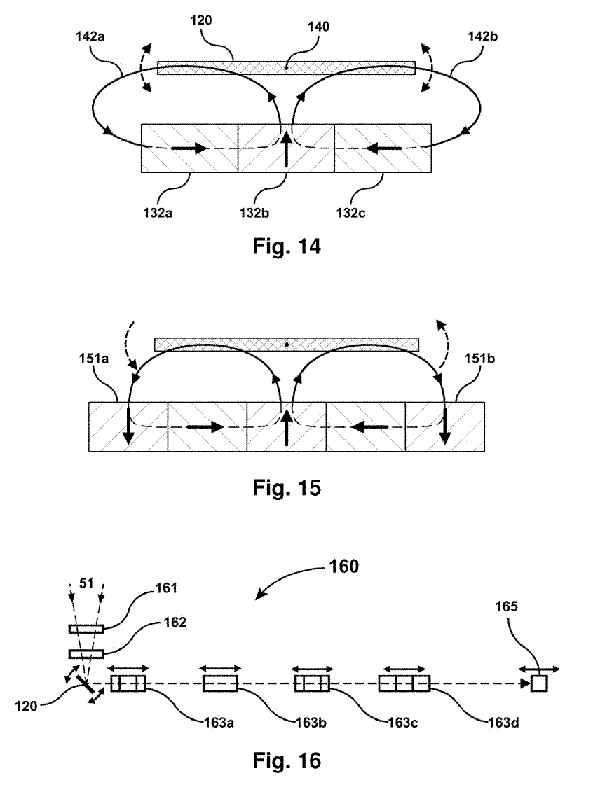

FIG. 14 is a section view of mirror segment 120 and magnets 132a, 132b and 132c illustrating the operation of MEMS mirror 110. The polarities of magnets 132a, 132b and 132c create a magnetic field with two lobes, 142a and 142b, which point in opposite directions (as shown by directional arrows) and eliminate the need for a separate conductive loop on the mirror segment as in the prior art. Instead, mirror segment 120 is fabricated from a conductive and optically reflective material such as aluminum or includes both conductive and optically reflective layers, making at least part of the thickness of mirror segment 120 conductive while making the entire top surface of mirror segment 120 highly reflective. An electric current passing through mirror segment 120 from contact pad 124a to contact pad 124b interacts with magnetic field lobes 142a and 142b according to Fleming's left-hand rule for motors. This creates an upward force on one side of mirror segment 120 and a downward force on the opposite side of mirror segment 120, causing mirror segment 120 to rotate along a limited angle around axis 140. If the direction of the electric current through mirror segment 120 is reversed the upward and downward forces are also reversed, causing mirror segment 120 to rotate in the opposite direction around axis 140. By controlling the current through mirror segment 120 the speed of rotation and the final angle may be rapidly and precisely varied, subject to the counterforce and material limitations of torsion springs 122a and 122b. Because the conductive path may be much or all of the width of mirror segment 120, the resistance of the conductive path may be much lower than that of a separate conductive loop as found in the prior art, thus increasing performance and decreasing power consumption. Eliminating the separate conductive loop also increases the area of the reflective surface of mirror segment 120, decreasing the required device size and removing fabrication steps, both of which reduce costs. While the embodiment illustrated in FIG. 14 provides three magnets, 132a, 132b and 132c, other embodiments may use a single magnet with a multipole magnetization pattern that is substantially equivalent to that shown in FIG. 14 without straying from the intended scope of the present invention.

FIG. 15 is a section diagram of a second embodiment of the magnets of MEMS mirror 110. In this embodiment, magnets 151a and 151b are appended to the ends of the magnet configuration of FIG. 14, which serves to further shape and constrain the magnetic field lobes. Again, other embodiments may use a single magnet with a multipole magnetization pattern that is substantially equivalent to that shown in FIG. 15 without straying from the intended scope of the present invention.

FIG. 16 depicts a section view of optical path 160 according to the present invention. Light rays 51 (shown by dotted lines throughout) enter through an entrance pupil 161 which is a lens or window that is long and narrow similar to the lens slices of optical path 100 in FIG. 9B.

Optical path 160 may also include a controllable shutter or variable neutral density filter 162, which may be placed in the position shown or elsewhere in the optical path, to vary the amount of light allowed or the depth of focus. Light rays 51 then reflect from MEMS scan mirror segment 120 and continue through lens elements 163a, 163b, 163c, and 163d, which are also lens slices as shown in optical path 100 of FIG. 9B. It should be understood that the lens or window 161 may be a suitably configured entrance pupil shaped and dimensioned so as to broaden the effective scan angle of the scan mirror 120.

Finally light rays 51 strike image sensor 165, which is long and narrow similar to image sensor 104 of FIG. 9. An exemplary embodiment includes four lens elements, some or all of which may be movable along the optical path to implement variable focus and/or variable magnification, i.e. zoom. In other embodiments, the lens may consist of a single element or many elements in several groups, with all elements of some groups moving together as one. In some embodiments image sensor 165 may also be configured to move along the optical path to assist with zoom and/or focus. Lens or image sensor movement is illustrated by solid arrows adjacent each and may be accomplished by a mechanical device such as a thumbwheel turned by the operator, or by electro-mechanical actuators such as piezo-electric actuators, voice-coils, shape-memory alloy actuators or motor-driven gear assemblies with or without being augmented by cams. Movement is typically controlled by operator buttons and/or by a digital processor.

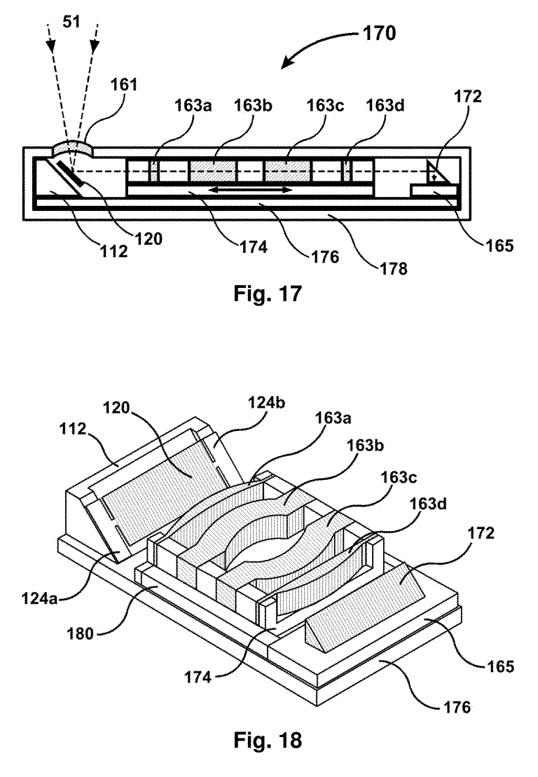

FIG. 17 shows a section view of a first embodiment of a camera module 170 that employs lens slices and a thin image sensor as in optical path 100 of FIG. 9B, a MEMS scan mirror as in FIG. 11, and the optical path structure of FIG. 16. Light rays 51 enter through lens or window 161, reflect from scan mirror segment 120 located on mirror base 112, continue through lens elements 163a, 163b, 163c, and 163d, reflect from mirror prism 172, and come to a focus on horizontally mounted image sensor 165. Lens elements 163a, 163b, 163c, and 163d form a single group attached to lens base 174 which slides (in directions indicated by double-ended solid arrows) over printed circuit board 176 along the optical path to implement variable focus. Some embodiments may include an infrared filter in the optical path as well. The aforementioned module components are soldered or bonded to printed circuit board 176, which provides connections between them for control and data signals. Cover or case 178 surrounding the module components excludes stray light. This first embodiment results in a camera module that may be less than 5 millimeters thick, while providing the full capability of a conventional camera module and substantially increasing light collection area. For example, while the entrance pupil of a conventional camera module may be 2 millimeters in diameter or less, the entrance slit in camera module 170 may be on the order of 2 millimeters by 10 millimeters, providing more than six times as much light collection area. In other embodiments camera modules could be thinner or thicker, depending on the capabilities required, the dimensions of the image sensor, and choices in the operating sequence described below.

FIG. 18 shows a perspective view of camera module 170 with cover 178 removed. Contact pads 124a and 124b may be soldered directly to the surface of printed circuit board 176. Lens elements 163a, 163b, 163c, and 163d are mounted in slots in lens base 174. Linear actuator 180 moves lens base 174 toward or away from image sensor 165 to vary focus. The entire camera module 170 may be 20 millimeters long, 15 millimeters wide and 4 millimeters thick, or less.

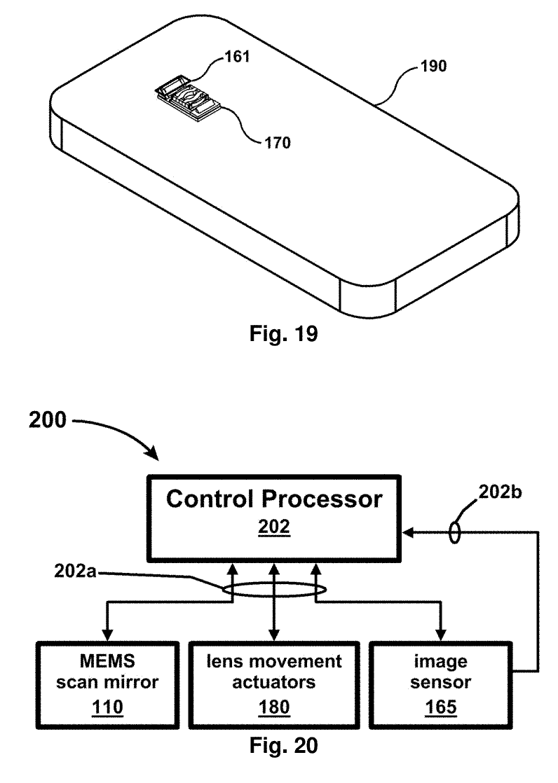

FIG. 19 shows a partial cutaway perspective view of a compact device 190, such as a cell phone, that includes camera module 170. Window or lens 161 is visible on the back side of the device, and operation is controlled through the usual operator interface, typically touch control on a display screen on the front of the device and buttons mounted on the front and/or sides. In this embodiment the lens provides a single focal length with variable focus. However, because the focal length may only be limited by the length and/or width of compact device 190, rather than the thickness of compact device 190, the present invention allows embodiments that implement thin versions of many different optical paths well known in the art. This includes wide angle lenses, telephoto lenses and zoom lenses. The entrance slit may also be increased in size, to 2 mm by 20 mm, for example, or even larger, greatly increasing light collecting area with little or no increase in the thickness of the device.

FIG. 20 is a diagram of control system 200 of camera module 170. Control processor 202 is typically mounted on the back side or an extension of circuit board 176. Control and status lines 202a connect control processor 202 to MEMS scanning mirror 110, lens focus actuators 180 and image sensor 165. Image data 202b from image sensor 165 is also routed to the control processor for processing and storage. In other embodiments, the control processor may also be connected to zoom lens actuators, a variable aperture control and/or other active elements. The maximum angular field of view of MEMS scanning mirror 110 may be determined by the maximum angular capability of MEMS scan mirror 110, or may be increased by a preceding lens (such as lens 161 as seen in FIG. 17). The angular field of view actually used may be limited to a variable fraction of the maximum by directing the control processor to limit the rotation angle of the scan mirror.

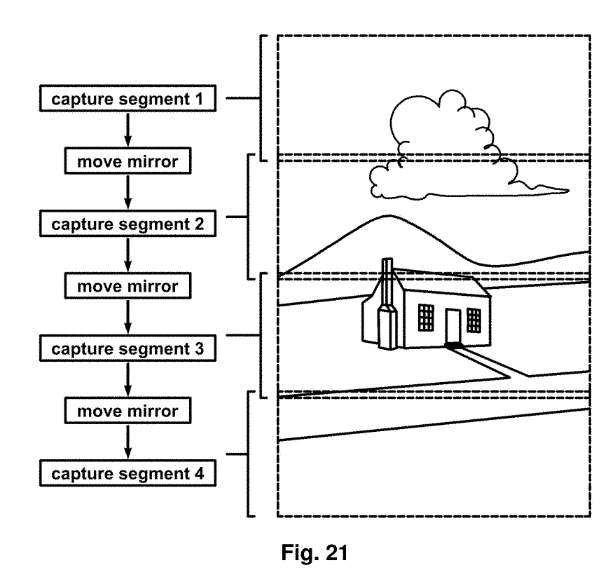

FIG. 21 depicts the image scanning procedure used by camera module 170. With mirror segment 120 rotated to the designated scan limit in one direction, image sensor 165 captures a first image segment and transfers the first image segment to control processor 202. Control processor 202 then provides the appropriate current direction and amplitude through mirror segment 120 to rotate the mirror segment one third of the way toward the second designated scan limit, where image sensor 165 captures a second image segment and transfers the second image segment to control processor 202. This process repeats for image segments three and four, after which mirror segment 120 has reached the second designated scan limit from where mirror segment 120 started. Mirror rotation angle is precisely controlled and image segment capture is precisely timed such that each successive image segment overlaps the previous image segment to a small degree. In this first embodiment, scan mirror 120 pauses at four positions for as much time as is needed for image sensor 165 to capture an image segment.

As each image segment reaches control processor 202, a “stitching” program aligns that image segment with the previous segment and combines them to form a single, larger image. Because mirror segment 120 rotates on a single axis and provides successive image segments with a pre-defined relationship, the alignment algorithm may be simpler and faster than is typically the case when images are combined.

At the completion of the sequence the full image, formed from all four segments, is transferred by control processor 202 to storage memory and to the operator display of compact electronic device 190. The entire process typically requires a small fraction of a second, and thus may be used to provide either still images or video at various frame rates. In other embodiments, a full image may include more or less than four segments, and may capture a series of image segments as the scan mirror rotates in one direction, then capture another series of image segments as the scan mirror rotates back to the starting position, shortening the time between successive images.

Mirror segment 120 may also be employed to assist with optical image stabilization and/or improved resolution. In response to orientation information provided by, for example, gyroscopes included in device 190, mirror segment 120 may be rotated by small angles to compensate for camera shake around one axis. A mechanism may be added to one or more of the lens elements or to the image sensor to provide movement to compensate for camera shake around a second axis. This same mechanism may be used to provide one-half pixel offsets around both axes. An image segment may be captured at each offset and digitally combined, using techniques well known in the art, to provide a final image with higher resolution than the individual source images.

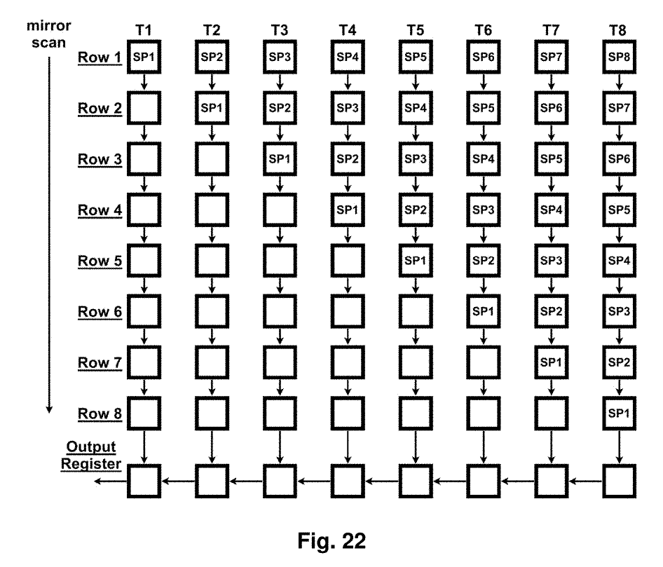

FIG. 22 is a diagram illustrating a Time Delay and Integration (TDI) scanning procedure that may be used in additional embodiments of camera modules according to the present invention. In this example, the image sensor includes eight rows of pixels and up to several thousand columns. Only one column is depicted, but the rest of the pixels in each row operate in the same fashion. As an image capture sequence begins, with the scan mirror at the beginning of the rotation angle, the scan mirror begins to rotate at a constant angular velocity. Pixel Row 1 begins collecting light from corresponding scene pixels, SP1, without stopping mirror rotation. Synchronously with mirror rotation, at Time 1 (T1) the image sensor transfers the contents of Row 1 to Row 2 and continues adding to the collected value. At T2 the contents of Row 2 are transferred to Row 3 and the contents of Row 1 are transferred to Row 2. As this process continues, the image sensor integrates light from each scene pixel as the mirror rotates, moving the scene pixels vertically down the columns of sensor pixels. When each scene pixel is transferred out of Row 8 the scene pixel arrives at the output register. During the next time interval the contents of the output register are shifted out horizontally for processing and storage. The scan mirror continues to rotate, the pixel columns continue to integrate and shift their contents downward, and the scene pixels are shifted out row by row until the full image has been captured. The scan mirror is then rotated back to the position where the scan process began in preparation to repeat the process. Because the scan mirror never stops rotating during an image capture sequence, the time required to capture a complete image may be shortened and the number of pixel rows required in the image sensor may be reduced.

TDI is used in aircraft and satellites to capture a continuous ground image as the vehicle passes over, and by industrial imaging systems to scan objects on a conveyor belt as they pass a stationary sensor. In those applications, camera movement with respect to the scene, or scene movement with respect to the camera, is used to produce the scanning effect. In the present invention, camera and scene are stationary, with the scanning effect produced by the scan mirror.

The camera modules described thus far provide a MEMS scan mirror that rotates through a limited angle in one direction, and then reverses direction. Other embodiments may provide a different scanning element such as a prism that rotates through a limited angle in one direction and then reverses direction. Still other embodiments may provide a prism or a multi-facetted scan mirror, such as a two-sided mirror, three-facet mirror, hexagonal mirror, and so on, that rotates on bearings continuously in one direction when activated. These camera modules capture successive images as each facet rotates past the lens assembly and image sensor.

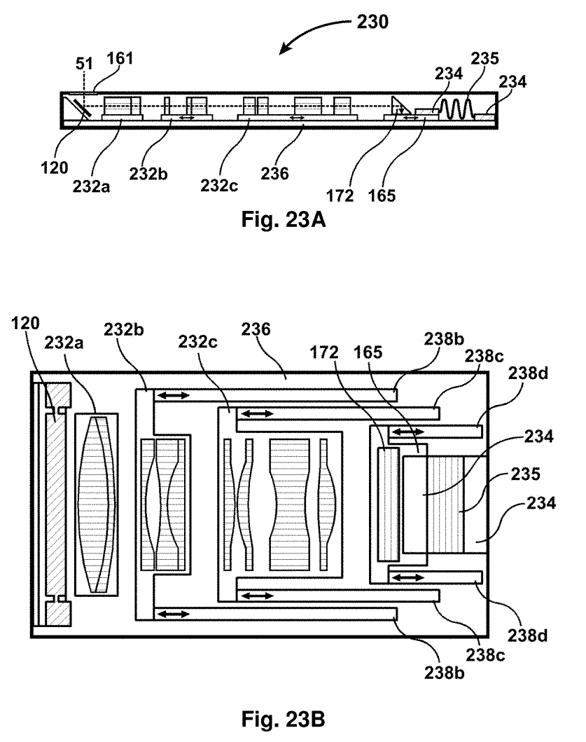

FIG. 23A shows a section view of another camera module embodiment 230, according to the present invention, that provides a zoom lens. FIG. 23B shows a plan view of camera module embodiment 230. Light rays 51 pass through lens or window 161, reflect from scan mirror segment 120, pass through lens groups 232a, 232b, and 232c, reflect from mirror prism 172, and focus onto image sensor 165. Lens group 232a includes two lens elements and remains stationary in close proximity to mirror segment 120. Lens group 232b includes three lens elements and is moved along the optical path by linear actuators 238b. Lens group 232c includes four lens elements and is moved along the optical path by linear actuators 238c. Image sensor 165 and mirror prism 172 are moved along the optical path by linear actuators 238d. All components are mounted on circuit board 236. Folding ribbon cable 235 is attached to image sensor 165 at one end and circuit board 236 at the other end via connectors 234. This configuration allows high-ratio zoom lenses to be implemented without the need to substantially increase the thickness of the camera module. Other embodiments may include more or fewer lens elements in each group, may include more or fewer groups, and all, some, or none of the lens groups may be movable. The image sensor may be either movable or stationary. Both wide angle and telephoto lenses may be implemented. The linear actuators may be replaced by a single actuator and cams to allow each of the lens groups to be moved by different amounts simultaneously.

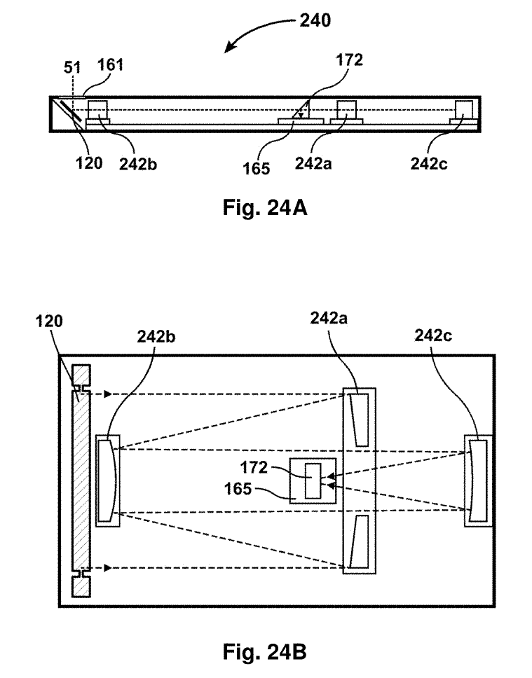

Embodiments of the present invention revealed thus far have employed refractive optics, but further embodiments may employ reflective optics. FIG. 24A shows a section view of a three mirror Willstrop telescope embodiment of a camera module 240. FIG. 24B shows a plan view of camera module 240. Light rays 51 pass through lens or window 161, reflect from scan mirror segment 120, reflect from primary mirror 242a, reflect from secondary mirror 242b, reflect from tertiary mirror 242c, reflect from mirror prism 172, and focus onto image sensor 165. The image sensor and/or some mirror elements may be movable via linear actuators, as described previously though not shown here, to adjust focus.

In other embodiments, the image sensor may be placed lower than the tertiary mirror, i.e. slightly off-axis, and the tertiary mirror lens tilted to direct light toward the sensor. This prevents the image sensor from obstructing incoming light, while the thinness of the mirror elements and mirror prism results in the need for only a slight tilt of the mirror lens and minimal image distortion. In still other embodiments, mirror optics may be used alone or in combination with refractive optics to implement thin versions of commonly known telescopic lens configurations such as Gregorian, Newtonian, Cassegrain, and others.

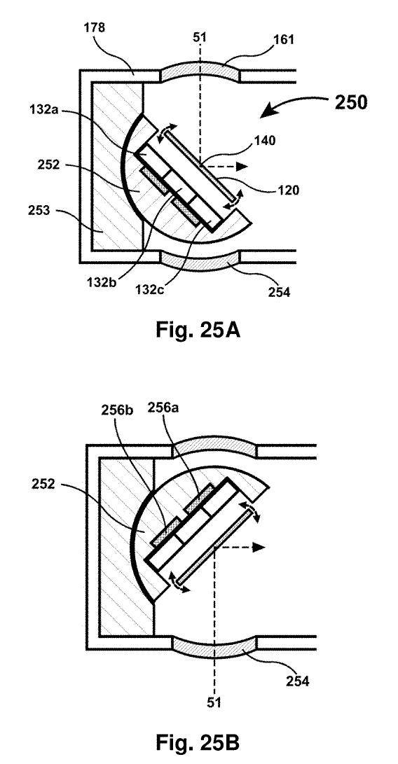

Many cell phones and other portable devices include a primary camera module with the associated aperture on the back side of the case, for example as shown in FIG. 19, and a secondary camera module with an aperture on the front side of the case for use in capturing “selfies” or for video conferencing. The secondary camera generally has lower resolution and performance than the primary camera to save space and cost. FIG. 25A and FIG. 25B show a section view of reversible scan mirror 250 for a two-aperture camera system that obviates the need for a secondary camera module. Light rays 51 pass through backside lens or window 161 and reflect from mirror segment 120, as described in previous embodiments. Magnets 132a, 132b, and 132c also remain unchanged. But in place of triangular mirror base 112 shown in FIG. 13, scan mirror 250 provides mirror base 252, shaped like a half-cylinder, with space for magnets 132a, 132b, and 132c and mirror segment 120 in the center. From the angular position shown in FIG. 25A, mirror base 252 rotates 90 degrees clockwise around mirror axis 140, sliding within the curved stationary base 253, to provide camera access to secondary lens or window 254 as shown in FIG. 25B. Current conductors 256a and 256b assist with mirror base rotation, as described below.

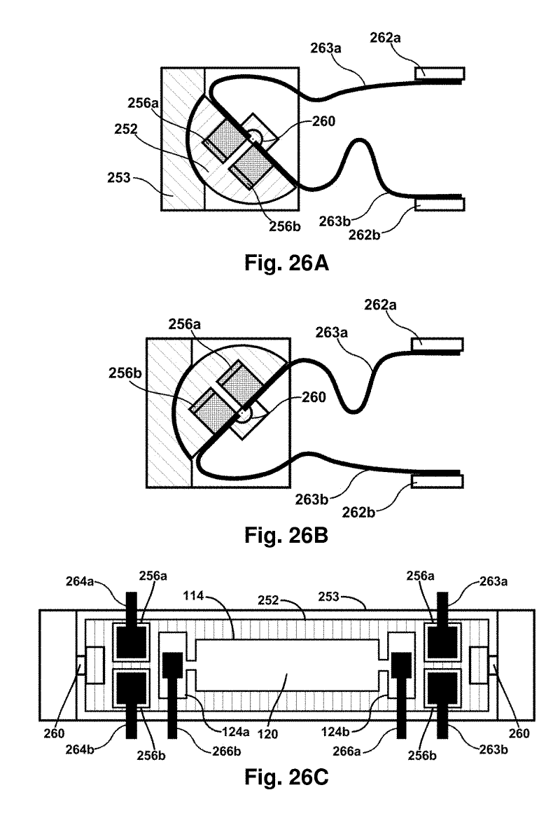

FIG. 26A and FIG. 26B show a section view taken near one end of reversible scan mirror 250, showing one half of the actuation mechanism. The opposite end of scan mirror 250 provides the second half of the actuation mechanism, identical to the first half, as shown in the plan view in FIG. 26C. One end of Shape Memory Alloy (SMA) wire 263a is electrically and mechanically connected to stationary connector 262a, and the other end is connected to mirror base conductor 256a. SMA wire 263a is typically nickel titanium (a/k/a nitinol) as is well known in the art, but may use other materials with the capability to bend and, when heated, return to the original shape. Mirror base conductor 256a runs downward from the surface of mirror base 252 and along the length of mirror base 252, underneath magnets 132a, 132b, and 132c as shown in FIGS. 25A and 25B, then back to the surface of mirror base 252 at the opposite end where mirror base conductor 256a connects to second SMA wire 264a. Stationary connector 262b, SMA wire 263b, mirror base conductor 256b, and SMA wire 264b follow a similar pattern. Two flexible conductive wires, 266a and 266b, provide a connection between the external control processor and contact pads 124a and 124b of mirror element 114 to allow control of mirror segment 120, as described previously.

In operation, with mirror base 252 starting from the position shown in FIG. 26A, an electric current flows from an external current source (not shown), through connector 262a, through SMA wire 263a, through mirror base conductor 256a, back through SMA wire 264a, through a second connector (not shown), and finally back to the external current source or to ground. This current causes the temperature of SMA wires 263a and 264a to increase, causing SMA wires 263a and 264a to “remember” their un-stretched shape and contract as shown in FIG. 26B. Mirror base 252 rotates around bearing 260, stretching unheated SMA wires 263b and 264b, as shown in FIG. 26B. This places scan mirror 120 in the correct position to reflect light from secondary lens or window 254, as shown in FIG. 25B. Current is only passed through the SMA wires when a change in mirror base position is desired. To return mirror base 252 to the original position of FIG. 26A the same procedure is followed, using the conductive path that runs from a second external current source, through connector 262b, through SMA wire 263b, through mirror base conductor 256b, back through SMA wire 264b and another connector (not shown), and finally back to the second external current source or to ground. SMA wires provide a very small, simple and low-cost actuation mechanism, but other actuator types may also be used including rotary electromagnetic actuators and manual thumbwheels or sliding switches without straying from the intended scope of the present invention.

Reversible scan mirror embodiments allow the operator to select a camera view from either the back or the front of the device, using the same high-performance camera in both cases. In other embodiments, the MEMS scan mirror could be replaced by a rotating scan mirror on a 2-position sliding mount that may be moved toward the front or the back of the device to achieve the proper image path for the desired direction.

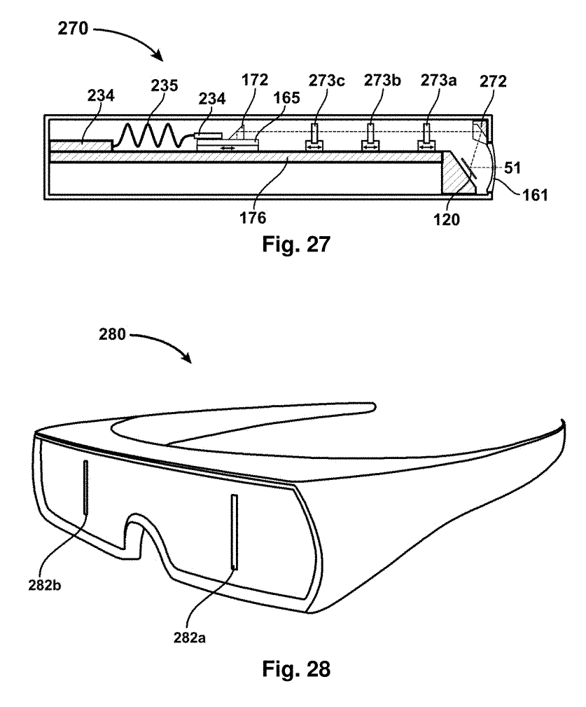

Embodiments of the present invention revealed thus far have all used a scanning element to collect light from directions centered roughly perpendicular to the optical path through the camera module lenses. FIG. 27 is a section view of thin camera module embodiment 270 that provides other features, including a configuration allowing a scanning element to collect light from directions centered roughly parallel to the optical path through the camera module lenses. Light rays 51 pass through lens or window 161, reflect from mirror segment 120, reflect from mirror prism 272, pass through movable lens elements 273a, 273b, and 273c, then reflect from mirror prism 172 and focus onto image sensor 165, which also is movable. In this embodiment lens elements 273a, 273b, and 273c are planar lenses, which provide extremely thin and lightweight lens elements with little or no chromatic aberration. This allows one very thin lens element to replace two or more thick lens elements usually required to concentrate or disperse light and correct the resulting chromatic aberration. In other embodiments lens elements 273a, 273b, and 273c may be replaced by more or fewer lenses or by groups of lenses, which may be planar, diffraction or refraction lenses.

Camera module 170 in FIG. 17 provides a field of view that is centered at an angle of 90 degrees away from the optical path through the lens elements. Camera module 270 in FIG. 27 provides a field of view that is centered in the same direction as the optical path through the lens elements. In other embodiments the center reflection angle of the scan mirror, the reflection angle of a mirror prism or mirror, and/or the deflection angle provided by an angle prism may be selected to provide a field of view that is centered at an angle anywhere between zero and 180 degrees away from the optical path through the lens elements.

Optical systems according to the present invention have applications in addition to camera modules. FIG. 28 shows a perspective view of binocular system 280 according to the present invention. This embodiment provides lenses or windows 282a and 282b for two cameras such as camera module 230 described in FIG. 23.

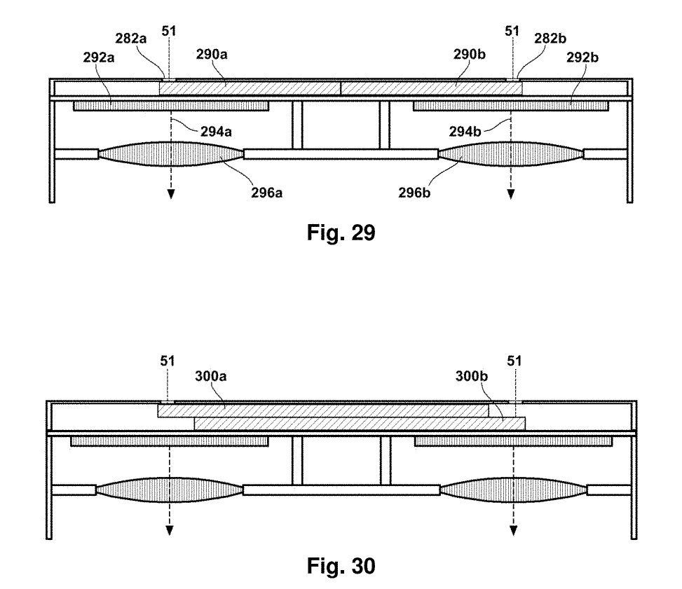

FIG. 29 shows a top section view of binocular system 280. Light rays 51 pass through lenses or windows 282a and 282b and continue into camera modules 290a and 290b, which are mounted end to end within binocular system 280. Single images or video streams detected by camera modules 290a and 290b are then sent to one or more control processors (not shown) included in the binoculars, and displayed on thin display screens 292a and 292b. Images 294a and 294b are focused by lenses 296a and 296b for viewing by the person wearing the binoculars. The result is a binocular system similar in size to an ordinary pair of safety goggles, but potentially with high magnification and controllable zoom. Because binocular system 280 is worn like a pair of eyeglasses binocular system 280 provides hands-free operation and is inherently stabilized with respect to the operator's eyes, removing both the difficulty of holding and aiming binoculars by hand and the image shake that results. Other data inputs may be electronically combined with sensed images to create augmented displays that provide the operator with, for example, the range to objects in the scene, compass headings and/or background information from relevant databases. Other embodiments may employ image sensors sensitive to non-visible wavelengths of light, such as infrared light, or may employ light amplification, to provide night vision.

FIG. 30 shows a section view of another embodiment of thin electronic binocular system 280. In this embodiment camera 300b is placed mostly behind camera 300a, with their apertures near opposite ends. This increases the thickness of binocular system 280 in exchange for an increase in the space available inside each camera module for a long focal length lens. The slight difference in distance from each camera module to the scene will have negligible result. In still other embodiments the two camera modules may be components of a mobile phone or other electronic device, providing the capability to capture stereo images and video.

The foregoing description of certain embodiments of the invention has been presented for the purposes of illustration and description. It is not intended to be exhaustive or to limit the invention to the precise form disclosed. Many modifications and variations are possible in light of the above teachings. Therefore, it is intended that the scope of the invention be limited not by this detailed description, but rather by the claims appended hereto.

What is claimed is:

1. A camera module comprising:
a first entrance pupil for transmission of light from a photographic subject;
a mirror segment having a longitudinal axis of rotation, said mirror segment being movable about said longitudinal axis thereby reflecting said light;
a plurality of truncated lenses aligned to transmit and focus said light reflected from said mirror segment; and
an image sensor aligned to receive said light transmitted and focused by said plurality of truncated lenses for subsequent digital manipulation thereof.

2. The camera module as claimed in claim 1 wherein said plurality of truncated lenses are mounted together in a base, said base being movable between said mirror segment and said image sensor.

3. The camera module as claimed in claim 2 further including a linear actuator operably attached to said base for movement thereof.

4. The camera module as claimed in claim 1 wherein said plurality of truncated lenses includes
a first group of truncated lenses affixed adjacent to said mirror segment, and
one or more additional group of truncated lenses, each said one or more additional group being movable between said first group and said image sensor.

5. The camera module as claimed in claim 4 wherein said one or more additional group include at least two groups of truncated lenses, said at least two groups being movable relative to one another.

6. The camera module as claimed in claim 5 further including
a first mirror prism aligned to receive said light transmitted and focused by said plurality of truncated lenses and transfer said light to said image sensor, said image sensor being located adjacent said first mirror prism.

7. The camera module as claimed in claim 6 wherein said first mirror prism is movable relative to said plurality of truncated lenses.

8. The camera module as claimed in claim 7 wherein each of said groups of truncated lenses and said first mirror prism include a corresponding linear actuator for movement thereof.

9. The camera module as claimed in claim 8 wherein said mirror segment is movable via torsion springs located at opposite ends thereof, said torsion springs being located between said mirror segment and contact pads, said contact pads being mounted to a trapezoidal wedge-shaped base at raised mounting pads located at each end of said trapezoidal wedge-shaped base, said trapezoidal wedge-shaped base being lower than said raised mounting pads in an area beneath said mirror segment so as to enable rotation of said mirror segment.

10. The camera module as claimed in claim 9 wherein said mirror segment is formed from a conductive material which magnetically interacts with magnets embedded in said trapezoidal wedge-shaped base so as to move said mirror segment between each said orientation upon passing an electric current through said mirror segment.

11. The camera module as claimed in claim 1 further including
a second entrance pupil for transmission of light from another photographic subject, said second entrance pupil located opposite said first entrance pupil, and
a curved stationary base within which said mirror segment is selectively rotated between a first position facing said first entrance pupil and a second position facing said second entrance pupil.

12. The camera module as claimed in claim 11 wherein selective rotation of said mirror segment is provided by a shape memory alloy wire electrically and mechanically connected to said curved stationary base.

13. The camera module as claimed in claim 1 further including a second mirror prism optically located between said mirror segment and said plurality of truncated lenses such that said light entering said first entrance pupil travels parallel to said light passing through said plurality of truncated lenses.

14. The camera module as claimed in claim 1 wherein said mirror segment is movable about said longitudinal axis into a series of discrete orientations, each said orientation thereby reflecting respective portions of said light.

15. The camera module as claimed in claim 14 wherein said subsequent digital manipulation includes digital stitching of discrete images corresponding to each of said discrete orientations.

16. The camera module as claimed in claim 1 wherein said mirror segment is movable about said longitudinal axis at a constant angular velocity providing an image capture sequence to said image sensor corresponding to respective portions of said light.

17. The camera module as claimed in claim 16 wherein said subsequent digital manipulation includes time delay and integration processing of said image capture sequence.

18. The camera module as claimed in claim 1 wherein said entrance pupil is configured to broaden an effective scan angle of said scan segment.

19. The camera module as claimed in claim 1 wherein said plurality of truncated lenses includes optical elements selected from a group consisting of refractive, reflective, diffractive, and planar elements.

20. A microelectromechanical device comprising: a mirror segment being movable via torsion springs located at opposite ends thereof, said torsion springs being located between said mirror segment and contact pads, said contact pads being mounted to a trapezoidal wedge-shaped base at raised mounting pads located at each end of said trapezoidal wedge-shaped base, said trapezoidal wedge-shaped base being lower than said raised mounting pads in an area beneath said mirror segment so as to enable rotation of said mirror segment, said mirror segment being formed from a conductive material which magnetically interacts with magnets embedded in said trapezoidal wedge-shaped base so as to move said mirror segment between each said orientation upon passing an electric current through said mirror segment.
